(19) United States
(12) Patent Application Publication
(10) Pub. No.: US 2006/0218971 A1
(43) Pub. Date: Oct. 5, 2006

(54) Synthetic quartz glass and process for producing a quartz glass body

(76) Inventors: Rolf Martin, Jena (DE); Gordon von der Goenna, Jena (DE); Ute Natura, Jena (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/350,286

(22) Filed: Feb. 9, 2006

Related U.S. Application Data
(60) Provisional application No. 60/651,514, filed on Feb. 10, 2005.

(51) Int. Cl. C03B 19/06; C03C 3/06

(52) U.S. Cl. 65/17.4; 501/54

(57) ABSTRACT

The invention relates to a synthetic quartz glass that can be produced by direct precipitation by means of flame hydrolysis of a silicon precursor, especially a chlorine-containing silicon precursor, which quartz glass when irradiated with laser pulses at a wavelength of 193 nm at an energy density (H) of up to H=1.5 mJ/cm² and at a repetition frequency of the laser pulses of up to R=4 kHz is characterized by the following properties:
in the range of energy densities of up to 1.5 mJ/cm², the equilibrium absorption of quartz glass rises sublinearly with the energy density for all repetition frequencies of the laser pulses; the dependency of the equilibrium absorption on the repetition frequency of the laser pulses is sublinear; and
the relationship of equilibrium absorption and energy density (H) can be described as a function of H^{1.7};
   the H₂ content being at least 0.2·10¹⁸ molecules/cm³. Other aspects of the invention relate to a process for producing such a synthetic quartz glass.

This application claims the benefit of the filing date of U.S. Provisional Application Ser. No. 60/651,514 filed Feb. 10, 2005 which is incorporated by reference herein.

### FIELD OF THE INVENTION

The invention relates in general to the production of synthetic quartz glass and especially to the production of a synthetic quartz glass with a small change of absorption when the energy density changes with laser irradiation in the wavelength range of roughly 193 nm. In this case, the energy density of the laser radiation is of the magnitudes as are conventional in optical systems for microlithography. The preferred application of this invention is the production and the use of synthetic quartz glass for producing components for microlithography at wavelengths of 193 nm.

### BACKGROUND OF THE INVENTION

Synthetic quartz glass has been and will continue in the future to be used to a greater extent as the raw material for optical lenses in objective lenses that are used in the semiconductor industry for photolithographic production of electronic components (processors, storage circuits, etc.). Of special importance here are the systems that work with laser radiation of a wavelength of roughly 193 nm. ArF excimer lasers that work in pulse operation with pulse repetition frequencies (rep. rates) from 1 kHz to 4 kHz or beyond are used as the radiation source for these 193 nm systems.

The high demands that are imposed on the quality of objective lenses for 193 nm working wavelengths also result in high demands on the material properties of the quartz glass that is used for objective lenses. Important material requirements for the quartz glass used follow from the action that is rendered by pulsed 193 nm laser radiation on quartz glass. The material specifications derived therefrom are intended to ensure that production conditions are as constant as possible in a photolithographic process by the constant imaging performance of the objective lenses.

The action of pulsed 193 nm laser radiation on the properties of quartz glass can be divided into short-term effects and into long-term effects. Long-term effects are produced by long-term laser irradiation, i.e., after pulse numbers in the giga range (I gigapulse=10⁹ pulses). The most important long-term effects are the increase in the absorption induced by the laser radiation at wavelengths around 193 nm and changes of the optical wavelength (OPD) by changes in length and the index of refraction in the irradiated quartz glass. Short-term effects arise when quartz glass is re-irradiated after production-dictated irradiation interruptions or is exposed to sudden changes in the energy density. The most important short-term effect that occurs in these changes in quartz glass is the change of the absorption at 193 nm as a function of the energy density of the optical radiation that is generally called RDP (rapid damage process). Since in the photolithographic production process neither irradiation interruptions nor short-term changes in the energy density can be avoided, the RDP, i.e., the change of absorption as a function of the energy density of the optical radiation, is specified for a given energy density range and for given repetition frequencies of the laser pulses.

In the material qualification of quartz glass for use in 193 nm systems, in the past the following procedure had been selected:

a) First of all, the transmission of a quartz glass sample at 193 nm for 4 different energy densities is measured in the range up to 1.5 mJ/cm² after exposure of the samples to a certain number of pulses (normally roughly 250,000 pulses). The quartz glass sample was not irradiated beforehand in this case.

b) The transmission behavior that is established is shown by way of example in FIG. 1a for three different energy densities. This transmission behavior was conventionally described by superposition of a linear function and an exponential function, and the absolute term of the curve fit was recorded as the transmission that belongs to the set energy density. Only at very low energy densities was an equilibrium state of transmission established; at higher energy densities, a continuous rise of transmission after an initial major decrease could be observed.

c) The transmission values (still dependent on the sample length) were converted into absorption values k that are independent of the sample length (i.e., a pure material property). The rise of absorption k with the energy density H, therefore the quantity dk/dH, is a measure of the intensity of the RDP and is called RDP below. This quantity was used for characterization of quartz glass samples.

A design of the measurement sensor hardware for measurement of the absorption at the laser measurement sites for repetition frequencies of laser pulses of greater than roughly 400 Hz had not been considered in the past, for which reason the measurement program was limited in the past to verification and characterization of the RDP at repetition frequencies of the laser pulses of less than 400 Hz. One important reason for this limitation to low repetition frequencies was the comparatively high costs, since the design of a measurement apparatus for characterization of quartz glass samples at high repetition frequencies of the laser pulses is very complicated and expensive. Up to these repetition frequencies during measurements (at a constant energy density each time and without prior irradiation), absorption proved to be dependent roughly linearly on the repetition frequency, so that it was regarded as adequate to linearly extrapolate from the repetition frequency at 400 Hz to the repetition frequencies of 2 kHz and 4 kHz that are conventional in photolithographic production.

In a series of complex tests, the inventors ascertained that the aforementioned procedure for characterization of quartz glass samples is not adequate, especially to characterize synthetic quartz glass under conditions as will be conventional in the intended applications in microlithographic exposure devices, especially photosteppers. This finding ultimately formed the basis for preparing synthetic quartz glass with even better properties in the intended application area.

### SUMMARY OF THE INVENTION

The object of this invention was thus to make available an improved synthetic quartz glass and a process for its production and for production of a quartz glass body with even better properties, especially with better properties under the conditions in microlithographic exposure devices.

This and other objects are achieved by a synthetic quartz glass according to claim 1, by a process for its production according to claim 7, and by a process for producing a quartz glass body according to claim 17. Other advantageous embodiments are the subject matter of the referenced claims.

According to a first aspect of this invention, a synthetic quartz glass is made available that can be produced by direct precipitation by flame hydrolysis of a silicon precursor, especially a chlorine-containing silicon precursor, such as, for example, silicon tetrachloride, which quartz glass when irradiated with laser pulses at a wavelength of 193 nm at an energy density (H) of up to H=1.5 mJ/cm² and at a repetition frequency of the laser pulses of up to R=4 kHz is characterized by the following properties:

in the range of energy densities of up to 1.5 mJ/cm² the equilibrium absorption of quartz glass rises sublinearly with the energy density for all repetition frequencies of the laser pulses;

the dependency of equilibrium absorption on the repetition frequency of the laser pulses is sublinear; and

the relationship of equilibrium absorption and energy density (H) can be described as a function of H^{1.7};

the H₂ content being at least 0.2·10¹⁸ molecules/cm³.

According to another aspect of this invention, a process is made available for producing a body from synthetic quartz glass, especially from a synthetic quartz glass according to the paragraph above, by direct precipitation of a raw quartz glass part by means of flame hydrolysis of a silicon precursor, especially of a chlorine-containing silicon precursor, the raw quartz glass part

being kept at an upper holding temperature in the range of from 950° C. to 1150° C., preferably 1050° C. to 1100° C., for at least 10 hours, more preferably for at least 20 hours, and

being cooled to a final cooling temperature with an average cooling rate of 1 K/h to 20 K/h, preferably from 2 K/h to 5 K/h,

and the H₂ content of the quartz glass body being set to at least 0.2·10¹⁸ molecules/cm³.

According to another aspect of this invention, a process for producing a quartz glass body from a raw quartz glass part of synthetic quartz glass is prepared as described above, optical absorption of the raw quartz glass part being measured for a plurality of laser pulses at a wavelength of 193 nm and at an energy density of up to H=1.5 mJ/cm² with a predetermined repetition frequency, after the raw quartz glass part has been irradiated with at least 2·10⁶ laser pulses, more preferably with at least 3·10⁶ laser pulses, with an energy density of at least 2.5 mJ/cm², more preferably of at least 3 mJ/cm², and the raw quartz glass part is rejected or further specially treated if an equilibrium value for optical absorption in the measurement is not established.

### LIST OF FIGURES

The invention is described in more detail below by way of example and with reference to the attached drawings, from which other features, advantages and objects to be achieved will arise, and in which:

FIG. 1a shows absorption of an identical quartz glass sample measured according to the prior art at different energy densities;

FIG. 1b shows the absorption measured using the measurement process according to the invention for the quartz glass sample according to FIG. 1a at different energy densities;

FIG. 2 shows the measured relationship between the equilibrium absorption and the irradiated energy density of a quartz glass sample and a linear regression test based on the measurement points;

FIG. 3 shows the equilibrium absorption of the quartz glass sample according to FIG. 2 as a function of the repetition frequency of the laser pulses for different energy densities;

FIG. 4 shows the equilibrium absorption of the quartz glass sample according to FIG. 2 as a function of the repetition frequency of the laser pulses for different energy densities and even higher repetition frequencies;

FIG. 5 shows in a comparative representation the extrapolation to equilibrium absorption at high repetition frequencies of the laser pulses for a quartz glass sample according to a conventional linear model and according to this invention;

FIG. 6 shows the relationship between the energy density and the equilibrium absorption for a quartz glass sample at different repetition frequencies of the laser pulses jointly with a model curve according to this invention;

FIG. 7 shows the measured relationship between the equilibrium absorption and the dose deposited by laser pulses for the measured values according to FIG. 6;

FIG. 8a shows transmission measured with the measurement process according to the invention for a quartz glass sample according to a first embodiment of the present invention as a function of the number of laser pulses used for measurement; and

FIG. 8b shows transmission measured with the measurement process according to the invention for a quartz glass sample according to another embodiment of the present invention as a function of the number of laser pulses used for measurement.

### DETAILED DESCRIPTION OF PREFERRED EMBODIMENTS

This invention is based on the use of synthetic quartz glass, preferably that which has been produced for years under the commercial name Lithosil™ Q1 E193 by the applicant. It is a high purity synthetic quartz glass that is produced according to the flame hydrolysis process by direct precipitation from a silicon precursor, especially also for use in photolithography, as a raw material for objective lenses of working wavelengths of 248 nm and 193 nm. In flame hydrolysis, the quartz glass is directly precipitated from a silicon-containing precursor, as is disclosed in, for example, WO 98/40319 of the applicant, the contents of which are hereby contained expressly by way of reference in this application.

Modified Measurement Specification

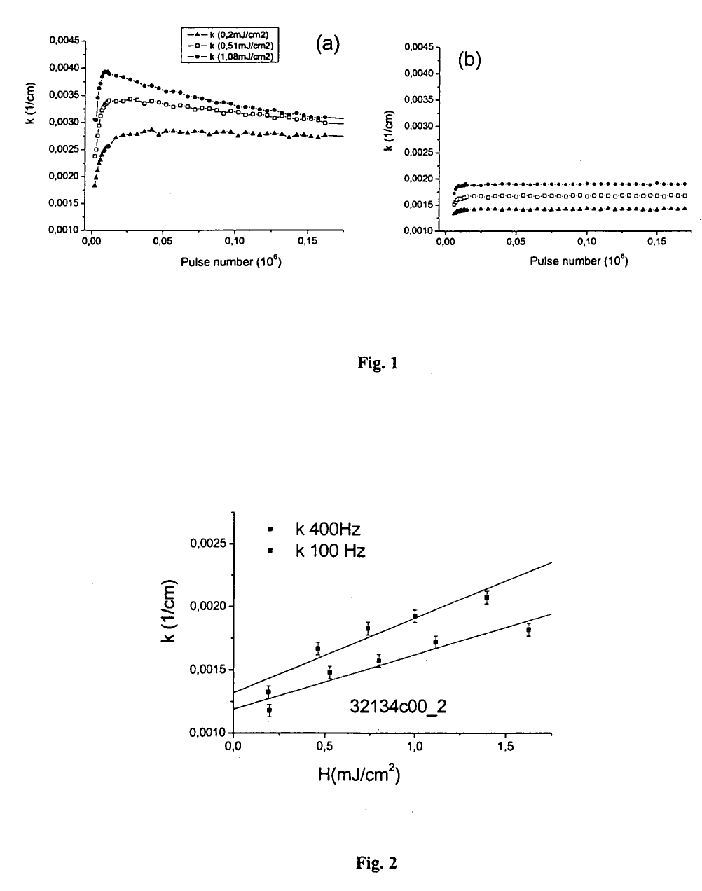

In a series of tests to determine the RDP, it was demonstrated that the original measurement specification, as was described above using FIG. 1a, is inadequate. Thus, it became clear that at the start of irradiation, a series of defects (especially ODC—oxygen deficiency center) are healed and later play no part for the properties of the material. It therefore proved important to eliminate these defects. Prior irradiation of the later measurement spot in the quartz glass sample on the laser measurement site is especially suitable. It was possible to show that upon irradiation with 2 million laser pulses at an energy density of 3 mJ/cm², a state was established in which in later measurements within less than 1000 laser pulses at each energy density, an equilibrium state of transmission was achieved.

The difference of absorption measurements with and without prior irradiation becomes clear from the comparison of FIG. 1a and FIG. 1b. Without prior irradiation (compare FIG. 1a), an equilibrium value of transmission is not quickly established. This entails the danger that in measurements for characterizing a sample, the sample is not irradiated long enough, so that characterization of the sample takes place based on nonequilibrium parameters. In contrast, upon prior irradiation of the sample (compare FIG. 1b) in the course of measurement, an equilibrium value of transmission is quickly established that can be easily converted into absorption that is independent of thickness and that is conclusive for the material.

Thus, according to the invention, to characterize the quartz glass samples, equilibrium absorptions or transmissions are determined under the following measurement conditions: the optical absorption of raw quartz glass parts is measured for a plurality of laser pulses at a wavelength of 193 nm and at an energy density of up to H=1.5 mJ/cm² with a predetermined repetition frequency after the raw quartz glass part has been irradiated with at least 2·10⁶ laser pulses, more preferably with 3·10⁶ laser pulses, with an energy density of at least 2.5 mJ/cm², more preferably with at least 3 mJ/cm².

RDP Measurements at Low Repetition Frequencies and Development of a Model for Description of the Behavior of Equilibrium Absorption

RDP measurements of up to a repetition frequency of laser pulses of 400 Hz were now taken for the synthetic quartz glass Lithosil™ Q1 E193 (standard quality) and for some experimentally altered modifications of this standard quality. Production conditions, hydrogen content (H₂) and RDP measurements are summarized in Table 1.

TABLE 1
Measurements of the RDP on Lithosil samples
of different production methods

| | 98042C00-2 | 32124C51-3 | 30114C00-2 |
|---|---|---|---|
| Melting Process | Vertical | Horizontal Melting | Horizontal |
| | Melting | and Counterboring | Melting |
| Additional | No | No | No |
| Subsequent Cooling | | | |
| of the Sample | | | |
| H₂ [10¹⁸/cm³] | 1.9 | 1.5 | 2.6 |
| kₒ [10⁻³/cm] | 1.65 | 1.26 | 1.28 |
| dk/dH [10⁻⁴/cm] | 5.6 | 4.8 | 4.6 |

The melting processes given in the table correspond to the melting process described in WO 98/40319 of the applicant, the terms “horizontal” and “vertical” relating to the alignment of the muffle and the two opposite openings for insertion of a preform and the burner. “Counterboring” in Table 1 means the subsequent forming of the preform (ingot), for example into a cylinder with a larger diameter and with repeated heat treatment.

Measurements showed that after prior irradiation on the samples, reproducible equilibrium transmissions for the individual energy densities of the laser radiation can be determined. In any case, a linear regression of the measured values was surprisingly not suited for description of the relationship of the quantity dk/dH. The determined curves rather indicated a sublinear dependency of the equilibrium absorption on the energy density, as is shown in FIG. 2, in which the measured equilibrium absorption is shown for two different repetition frequencies of the laser pulses and different energy densities. Linear regression is included in FIG. 2 as an aid, but obviously does not adequately describe the determined dependency.

As can furthermore be seen from Table 1, different production conditions lead to different values for dk/dH. This value is thus fundamentally suited for optimization of production conditions.

To describe the RDP, a model was developed that is explained in more detail below using the embodiment Lithosil™ Q1 E193, but that can also be fundamentally applied to other types of quartz glass. This model is based, on the one hand, on the fact that the dependency of transmission on the duration of irradiation must be described by at least two time constants and, on the other hand, on the fact that the same total energy added linearly per unit of time, i.e., repetition frequency, multiplied by the energy density, for different energy densities and repetition frequencies, does not have the same effect, since experimentally at higher energy densities, higher absorption values also always appeared. Therefore, a mathematical model was synthesized that is based on the fact that two different defects D1, D2 contribute to the measured absorption, to which defects different relaxation constants could be assigned. According to this model, the defect stage D1 is filled at small energy densities, while at high energy densities, a rise in charge carriers occurs from the stage D1 to the higher stage D2 and thus at high energy densities the occupancy of the stage D1 is less than at small energy densities. With this model, the above-described relationships of dk/dH could be described in a satisfactory manner.

Measurements at High Repetition Frequencies

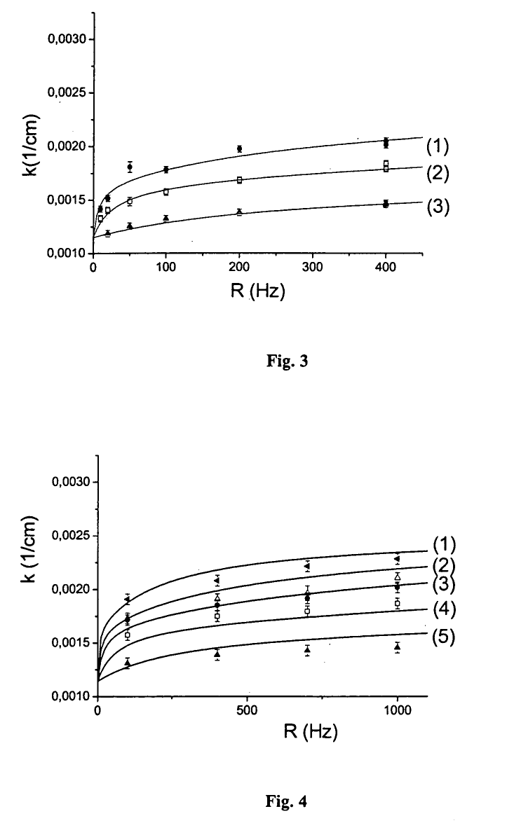

This model yielded the prediction that the absorption of synthetic quartz glass is a nonlinear function of the repetition frequency. To verify this prediction, the dependency of the absorption on the repetition frequency was first measured for frequencies below roughly 400 Hz. These measurements are summarized in FIG. 3. The nonlinear dependency is clearly recognizable. In FIG. 3, curve fits that follow from the model discussed above are also shown.

The model showed that the deviations between the previously assumed linear dependency and the nonlinear dependency predicted by the model for high frequencies should be especially strong. To verify this prediction and dictated by the above-explained model, the absorption according to this application was therefore determined for the first time also for comparatively high frequencies, as summarized in FIG. 4, especially for frequencies up to roughly 1 kHz. Therein, the nonlinear dependency is even more apparent than in FIG. 3. FIG. 4 also shows curve fits for the measurement points that are based on the model discussed above and enable outstanding agreement with the measured values.

Measurement Behavior at High Repetition Frequencies

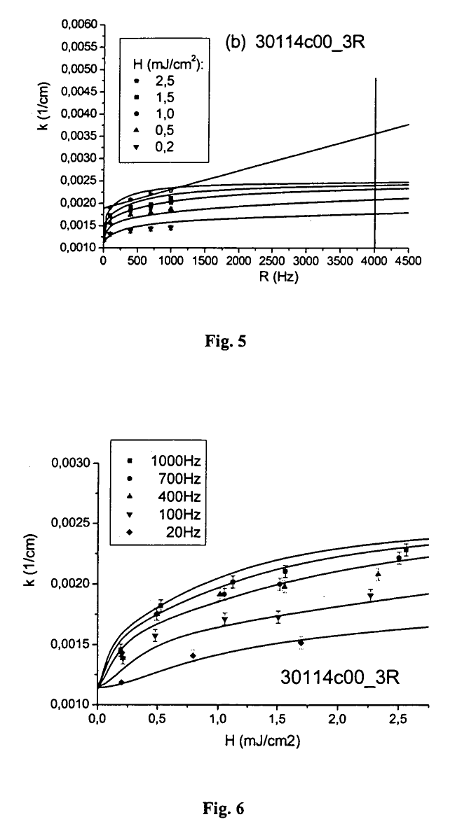

As is apparent from FIG. 4, for high repetition frequencies of the laser pulses using the above-discussed model, saturation of equilibrium absorption can be predicted. The resulting consequences are summarized in the comparative representation according to FIG. 5 that shows the relationship between the equilibrium absorption and the repetition frequency for the model curves that result from the model for different energy densities and for the conventionally assumed linear extrapolation of the measured values at low repetition frequencies or measurement frequencies.

According to FIG. 5, it can be assumed that the value of equilibrium absorption at the high repetition frequencies that are necessary for microlithographic applications in the range of a few kHz is in fact lower by a factor of 2 to 3 than assumed based on linear extrapolation.

Additional Verification of the Model

It furthermore follows from the above-discussed model that the energy density H and the equilibrium absorption that is established are also in a nonlinear relationship, and the functional dependency can be best described with k=f(H^{1.7})

For further verification of the model, FIG. 6 shows the relationship of the energy density and equilibrium absorption on a quartz glass sample at different repetition frequencies. The illustrated curves are based on the dependency according to the above-discussed model with H^{1.7} and are in good agreement with the measured values.

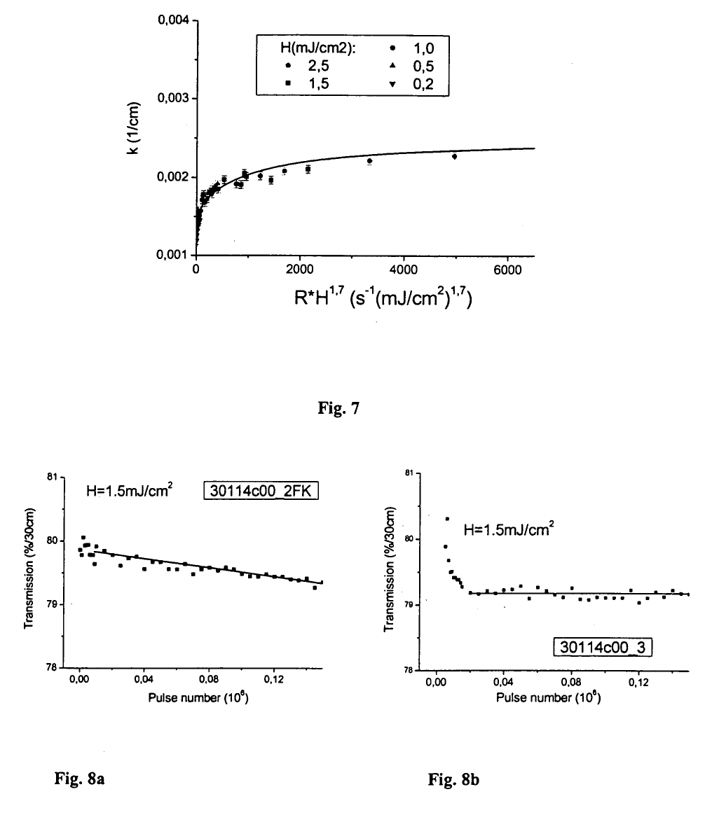

FIG. 7 shows the functional relationship between the equilibrium absorption and the deposited dose for the measured values according to FIG. 6. Saturation is clearly recognizable for high doses. The relationship between the equilibrium absorption and the deposited dose can be best described by a dependency with R·H^{1.7}, R designating the pulse repetition frequency (repetition rate).

The saturation of equilibrium absorption at high deposited doses is an experimental justification for the above explained measurement specification to measure the equilibrium absorption of a quartz glass sample only after suitable prior irradiation.

Effect of Cooling on the Quartz Glass Sample

Using the aforementioned measurement specification according to which the equilibrium absorption must be measured after suitable prior irradiation of the quartz glass sample, the effect of cooling of a raw quartz glass part on the RDP was determined. Table 2 below compares the results of a quartz glass sample that has been produced according to the invention with the corresponding results of the samples according to Table 1.

TABLE 2
Measurements of the RDP on Lithosil samples
of different production methods

| | | | | 30114C00- |
|---|---|---|---|---|
| | 98042C00-2 | 32124C51-3 | 30114C00-2 | 2FK |
| Melting | Vertical | Horizontal | Horizontal | Horizontal |
| Process | | and Counter- | | |
| | | boring | | |
| Additional | No | No | No | Yes |
| Subsequent | | | | |
| Cooling of | | | | |
| the Sample | | | | |
| H₂ [10¹⁸/cm³] | 1.9 | 1.5 | 2.6 | Below the |
| | | | | Detection |
| | | | | Limit |
| kₒ [10⁻³/cm] | 1.65 | 1.26 | 1.28 | 1.75 |
| dk/dH | 5.6 | 4.8 | 4.6 | 1.3 |
| [10⁻⁴/cm] | | | | |

The detection limit for H₂ was roughly 0.2·10¹⁸ molecules/cm³.

The data in columns 2 through 4 of Table 2 correspond to the data according to Table 1. In these samples, a standard cooling process for cooling the preform into a raw quartz glass part was done as follows: the preform immediately after direct precipitation by means of flame hydrolysis was kept at an upper holding temperature in the range of between roughly 950° C. and 1100° C. during a holding time of between roughly 6 hours and 12 hours, then the preform was cooled at a cooling rate of from roughly 5 K/h to roughly 50 K/h to a final cooling temperature between roughly 800° C. and 900° C.

The sample according to the last column of Table 2 was conversely subjected to an additional, subsequent cooling process, for which purpose the sample after cooling was reheated to an upper holding temperature and then cooled as follows: the sample was first heated to an upper holding temperature in the range of between roughly 950° C. and 1150° C., more preferably in the range of between roughly 1050° C. and 1100° C., and kept at the upper holding temperature during a holding time of at least roughly 10 hours, more preferably at least 20 hours; then the preform was cooled at a cooling rate of roughly 1 K/h to roughly 20 K/h, more preferably between roughly 2 K/h and roughly 5 K/h, to a final cooling temperature of between roughly 700° C. and roughly 950° C., preferably between roughly 800° C. and roughly 900° C.

This additionally cooled sample (30114C00-2FK) shows a clear improvement of the dk/dH value. The measured value proves the capacity of the RDP property to be influenced by the change of the cooling process.

FIG. 8a shows transmission of a quartz glass sample that has been produced in this way as a function of the number of laser pulses at an energy density of 1.5 mJ/cm², as corresponds to the intended applications in microlithography. During irradiation, induced absorption begins; this can be detected in the continuous drop of transmission during irradiation.

As a comparison, FIG. 8b shows the sample 30114c00_{—}3 at an identical energy density, which sample originates from the same sample batch, but which was not subjected to subsequent cooling. Determination of the H₂ content in the samples showed that the sample according to FIG. 8b still contained enough hydrogen, while the additional subsequent cooling of the sample according to FIG. 8a and the associated expulsion of the physically dissolved hydrogen could be made responsible for the induced absorption that occurs during irradiation. A value for the H₂ content of 0.2·10¹⁸ molecules/cm³ was determined as the critical value starting from which equilibrium absorption could be established.

In further complex test series, the effect of cooling on the RDP behavior was further-studied. It was found that promising approaches to reducing the RDP while maintaining the required low induced absorption consist in maintaining or establishing a suitable hydrogen concentration in the quartz glass sample by means of the following process variants:

(i) in the ascertained improved cooling shown in Table 2 in an air atmosphere, the dimensions of the quartz part are chosen to be so large that after this cooling, a relatively large internal volume of the quartz part with a relatively high H₂ content remains; edge areas with inadequate H₂ content must optionally be removed;

(ii) The ascertained improved cooling shown in Table 2 is not done in an air atmosphere, but in a hydrogen atmosphere. The hydrogen concentration in the annealing oven that is necessary in doing so can be set via the pressure of the hydrogen gas in the annealing oven according to the required minimum content of hydrogen in the quartz glass, as disclosed in EP 1 288 169 A1, the contents of which are hereby contained expressly by way of reference in this application;

(iii) After the ascertained improved cooling shown in Table 2 in an air atmosphere, subsequent enrichment of the quartz parts with hydrogen takes place in additional annealing at a much lower temperature and adapted hydrogen concentration in the oven, as disclosed in EP 1 288 169 A1.

The results of these tests are summarized by way of example in Table 3 below.

TABLE 3

| | 98042C00-3 | 98042C00-3FK | 98042C00-3FKH2 | 32124C51-FKP5 | 98024C00-30M |
|---|---|---|---|---|---|
| Cooling of | Volume | Sample | Sample | Volume | Volume |
| Holding Temperature [° C.] | 1070 | 1070 | 1070 | 1070 | 1070 |
| Holding Time [Hours] | 10 | 20 | 20 | 20 | 3 |
| Cooling Rate [K/h] | 7 | 3 | 3 | 3 | 30 |
| Final Temperature [° C.] | 850 | 850 | 850 | 850 | 850 |
| H₂ Loading | No | No | Yes | No | No |
| H₂ Content [10¹⁸ cm⁻³] | 2.3 | Below the | 1.5 | 0.2 | 2.2 |
| | | Detection | | | |
| | | Limit | | | |
| kₒ [10⁻³] | 1.86 | 2.04 | 1.73 | 1.73 | 2.18 |
| dk/dH [10⁻⁴] | 4.6 | 1.7 | 1.9 | 1.6 | 7.9 |

The first column of Table 3 gives a comparison sample with the aforementioned standard cooling as the reference; the boldfaced parameters describe the cooling process according to the invention.

In samples with an H₂ content of greater than 0.2·10¹⁸ molecules/cm³, induced absorption was not observed during irradiation. This was to be expected based on earlier studies on induced absorption (cf. U. Natura, O. Sohr, R. Martin, M. Kahlke, G. Fasold: “Mechanisms of Radiation-Induced Defect Generation in Fused Silica,” Proceedings of SPIE Volume 5273, 155-163 (2003)), in which it was shown that the concentration of precursor defects that can lead to induced absorption in Lithosil is <1·10¹⁷ molecules/cm³; the remaining hydrogen content is therefore sufficient for healing of these defects.

Altogether, the necessary H₂ content in quartz glass is at least 0.2·10¹⁸ molecules/cm³, preferably 0.2·10¹⁸ molecules/cm³ to 3·10¹⁸ molecules/cm³.

According to another embodiment, in a cooled raw quartz glass part that was cooled in an air atmosphere from the holding temperature to the final cooling temperature, to adjust the hydrogen content, the hydrogen content of the raw quartz glass part was determined at least in sections, for example by means of Raman spectroscopy, and based on the hydrogen content that was determined in this way, the parameter for another temperature cycle for the raw quartz glass part in a hydrogen atmosphere at normal pressure was computed, and the temperature cycle was carried out under a hydrogen atmosphere at normal pressure.

According to another embodiment, the H₂ content was determined for the outer edge areas of the raw quartz glass part, and the outer edge area was removed from the raw quartz glass part with an H₂ content of less than 0.2·10¹⁸ molecules/cm³.

Since hydrogen and oxygen are used as the gases for flame hydrolysis, and silicon tetrachloride (SiCl₄) is used as the chorine-containing silicon precursor, the chlorine (Cl) content in the quartz glass is typically at least 5 mass-ppm, according to some embodiments at least 20 mass-ppm. The chlorine content is furthermore preferably at most 50 mass-ppm, more preferably at most 40 mass-ppm. Here, the content of SiOH in the quartz glass can be 800 to 1400 mass-ppm, preferably 1000 to 1200 mass-ppm.

To characterize such raw quartz glass parts, the optical absorption of the raw quartz glass part was measured for a plurality of laser pulses at a wavelength of 193 nm and an energy density of up to H=1.5 mJ/cm² with a predetermined repetition frequency after the raw quartz glass part has been irradiated with at least 2·10⁶ laser pulses, more preferably with at least 3·10⁶ laser pulses, at an energy density of at least 2.5 mJ/cm², more preferably of at least 3 mJ/cm². Then, the raw quartz glass part was rejected or further specially treated when an equilibrium value for optical absorption in the measurement is not established. As stated above, by running another temperature cycle under suitable conditions, especially the hydrogen content of the atmosphere, the hydrogen content of the raw quartz glass part could be suitably adjusted.

In doing so the raw quartz glass part can then, for example, be rejected or further specially treated when the equilibrium value for optical absorption after irradiation of at most 10 minutes has not been established.

According to another embodiment, the equilibrium value for optical absorption for a plurality of predetermined repetition frequencies is measured and extrapolated from certain repetition frequencies to an equilibrium value for optical absorption for high repetition frequencies, as stated above, and the raw quartz glass part is rejected or further specially treated if the optical absorption extrapolated for high repetition frequencies exceeds a predetermined boundary value.

The procedure above can of course also be used for characterization, rejection or separate treatment of raw quartz glass parts for producing a quartz glass body with suitable induced absorption.

Thus, according to the invention, preparing a synthetic quartz glass with improved properties for microlithographic applications, especially with reference to reliable adherence to material specifications that relate to induced absorption, is made possible.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosures of all applications, patents and publications, cited herein and of corresponding U.S. Provisional Application Ser. No. 60/651,514, filed Feb. 10, 2005, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A synthetic quartz glass, which can be produced by direct precipitation by flame hydrolysis of a silicon precursor, especially a chlorine-containing silicon precursor, which quartz glass when irradiated with laser pulses at a wavelength of 193 nm at an energy density (H) of up to H=1.5 mJ/cm² and at a repetition frequency of the laser pulses of up to R=4 kHz, is characterized by the following properties:
in the range of energy densities of up to 1.5 mJ/cm², the equilibrium absorption of quartz glass rises sublinearly with the energy density for all repetition frequencies of the laser pulses;
the dependency of the equilibrium absorption on the repetition frequency of the laser pulses is sublinear; and
the relationship of equilibrium absorption and energy density (H) can be described as a function of H^{1.7};
the H₂ content being at least 0.2·10¹⁸ molecules/cm³.

2. The synthetic quartz glass according to claim 1, whereby the relationship of equilibrium absorption and energy dose (R·H) can be described as a function of R·H^{1.7} and is saturated for large doses.

3. The synthetic quartz glass according to claim 2, whereby hydrogen and oxygen are used as the gases for flame hydrolysis, and the chorine-containing silicon precursor is silicon tetrachloride (SiCl₄).

4. The synthetic quartz glass according to claim 2, whereby the content of chlorine (Cl) in the quartz glass is 5 to 50 mass-ppm.

5. The synthetic quartz glass according to claim 2, whereby the content of SiOH in the quartz glass is 800 to 1400 mass-ppm, preferably 1000-1200 mass-ppm.

6. The synthetic quartz glass according to claim 2, whereby the H₂ content in the quartz glass is at least 0.2·10¹⁸ molecules/cm³, preferably 0.2·10¹⁸ molecules/cm³ to 3·10¹⁸ molecules/cm³.

7. The synthetic quartz glass according to claim 1, said synthetic quartz glass comprising said properties after being irradiated with at least 2·10⁶ laser pulses, more preferably with at least 3·10⁶ laser pulses, at an energy density of at least 2.5 mJ/cm², more preferably of at least 3 mJ/cm².

8. A process for producing a body from synthetic quartz glass by direct precipitation of a raw quartz glass part by means of flame hydrolysis of a silicon precursor, especially of a chlorine-containing silicon precursor, whereby the raw quartz glass part
is kept at an upper holding temperature in the range of from 950° C. to 1150° C., preferably 1050° C. to 1100° C., for at least 10 hours, more preferably for at least 20 hours, and
is cooled to a final cooling temperature with an average cooling rate of 1 K/h to 20 K/h, preferably from 2 K/h to 5 K/h,
and the H₂ content of the quartz glass body is set to at least 0.2·10¹⁸ molecules/cm³.

9. The process according to claim 8, whereby the raw quartz glass part that has been cooled after flame hydrolysis is heated to the upper holding temperature.

10. The process according to claim 9, whereby the final cooling temperature is 700° C. to 950° C., preferably 800° C. to 900° C.

11. The process according to claim 9, whereby the raw quartz glass part is thermally formed into a quartz glass body after direct precipitation in at least one step.

12. The process according to claim 9, whereby to adjust the H₂ content of the quartz glass body, the raw quartz glass part is cooled in an air atmosphere or in a hydrogen atmosphere under normal pressure from the holding temperature to the final cooling temperature.

13. The process according to claim 9, whereby the raw quartz glass part is cooled in an air atmosphere from the holding temperature to the final cooling temperature, whereby to adjust the H₂ content of the quartz glass body, the H₂ content of the raw quartz glass part is determined at least in sections, and based on the H₂ content that was determined in this way, the parameter for another temperature cycle for the raw quartz glass part in a hydrogen atmosphere at normal pressure is computed, and the temperature cycle is carried out under a hydrogen atmosphere at normal pressure.

14. The process according to claim 9, whereby the H₂ content is determined for the outer edge areas of the raw quartz glass part and the outer edge areas are removed from the raw quartz glass part with an H₂ content of less than 0.2·10¹⁸ molecules/cm³.

15. The process according to claim 9, whereby optical absorption of the raw quartz glass part is measured for a plurality of laser pulses at a wavelength of 193 nm and at an energy density of up to H=1.5 mJ/cm² with a predetermined repetition frequency, after the raw quartz glass part has been irradiated with at least 2·10⁶ laser pulses, more preferably with at least 3·10⁶ laser pulses, at an energy density of at least 2.5 mJ/cm², more preferably of at least 3 mJ/cm², the raw quartz glass part being rejected or further specially treated if an equilibrium value for optical absorption in the measurement is not established.

16. The process according to claim 15, whereby the raw quartz glass part is rejected or further specially treated when an equilibrium value for optical absorption after irradiation of at most 10 minutes has not been established.

17. The process according to claim 15, whereby the equilibrium value for optical absorption for a plurality of predetermined repetition frequencies is measured and extrapolated from certain repetition frequencies to an equilibrium value for optical absorption for high repetition frequencies, and the raw quartz glass part is rejected or further specially treated if the optical absorption extrapolated for high repetition frequencies exceeds a predetermined boundary value.

18. A process for producing a quartz glass body from a raw quartz glass part of a synthetic quartz glass according to claim 1, whereby an optical absorption of the raw quartz glass part is measured for a plurality of laser pulses at a wavelength of 193 nm and at an energy density of up to H=1.5 mJ/cm² with a predetermined repetition frequency, after the raw quartz glass part has been irradiated with at least 2·10⁶ laser pulses, more preferably with at least 3·10⁶ laser pulses, at an energy density of at least 2.5 mJ/cm², more preferably of at least 3 mJ/cm², and the raw quartz glass part is rejected or further specially treated if an equilibrium value for optical absorption in the measurement is not established.

19. The process according to claim 18, whereby the raw quartz glass part is rejected or further specially treated when an equilibrium value for optical absorption after irradiation of at most 10 minutes has not been established.

20. The process according to claim 18, whereby the equilibrium value for optical absorption for a plurality of predetermined repetition frequencies is measured and extrapolated from certain repetition frequencies to an equilibrium value for optical absorption for high repetition frequencies and the raw quartz glass part is rejected or further specially treated if the optical absorption extrapolated for high repetition frequencies exceeds a predetermined boundary value.
